(19) United States
(12) Patent Application Publication
(10) Pub. No.: US 2022/0145857 A1
(43) Pub. Date: May 12, 2022

(54) METHOD AND SYSTEM FOR CONTROLLING A WIND ENERGY INSTALLATION ARRANGEMENT

(71) Applicant: Siemens Gamesa Renewable Energy Service GmbH, Hamburg (DE)

(72) Inventor: Hennig Harden, Hamburg (DE)

(21) Appl. No.: 17/434,162

(22) PCT Filed: Feb. 26, 2020
(86) PCT No.: PCT/EP2020/055033

§ 371 Date: Aug. 26, 2021

(30) Foreign Application Priority Data
Feb. 26, 2019 (DE) 10 2019 001 356.5

(51) Int. Cl. F03D 7/04; F03D 7/02

(52) U.S. Cl. CPC F03D 7/046; F03D 7/026; F03D 7/0244

(57) ABSTRACT

A method for controlling a wind energy installation arrangement having at least one wind energy installation. The method includes determining pairs of values of a first quantity which depends on a wind speed, and a second quantity which depends on a power of the wind energy installation arrangement, and determining eigenvalues and/or eigenvectors of a covariance matrix of the pairs of determined values. The method may further include determining at least one intensity value that is dependent on a standard deviation and a mean value of a rotational speed and/or a torque of the wind energy installation arrangement and/or of a wind speed, and determining a value of a control parameter of the wind energy installation arrangement with the aid of an artificial intelligence based on the eigenvalues and/or eigenvectors and/or the at least one intensity value. The wind energy installation arrangement is controlled based on the control parameter value.

### CROSS-REFERENCE TO RELATED APPLICATIONS

This application is a national phase application under 35 U.S.C. § 371 of International Patent Application No. PCT/EP2020/055033, filed Feb. 26, 2020 (pending), which claims the benefit of priority to German Patent Application No. DE 10 2019 001 356.5, filed Feb. 26, 2019, the disclosures of which are incorporated by reference herein in their entirety.

### TECHNICAL FIELD

The present invention relates to a method and a system for controlling a wind energy installation arrangement which comprises at least one wind energy installation, as well as a computer program product for carrying out the method.

### BACKGROUND

As a function of environmental influences such as in particular wind, temperature, ice and the like, aging effects and pollution effects, changes in vegetation, conditions of a power grid, in particular weak grids, voltage dips or the like, the optimal operating conditions of wind energy installations change, and in particular those of wind energy installation arrangements which comprise several wind energy installations (“wind farms”).

### SUMMARY

It is an object of the present invention to improve the operation, in particular the performance, of a single wind energy installation or of a wind energy installation arrangement which comprises a plurality of wind energy installations.

This problem is solved by a method, a system, and a computer program product for carrying out a method as described herein.

In accordance with a first aspect of the present invention, a method of controlling a wind energy installation arrangement, which wind energy installation arrangement comprises one or more wind energy installations, or in particular consists of one or more wind energy installations, comprises the steps of:
determining pairs of values of
a first quantity which depends on a wind speed, in particular its absolute value and/or its direction, or which, in accordance with one embodiment, indicates or describes this, and
a second quantity which depends on a power, in particular an electrical power and/or a mechanical power of the wind energy installation arrangement, in particular on the individual power of the single wind energy installation of the wind energy installation arrangement or on the total power of the plurality of wind energy installations of the wind energy installation arrangement, or which, in accordance with one embodiment, indicates or describes this;
determining of eigenvalues and/or eigenvectors of a covariance matrix of these pairs of values which have been determined;
determining a value of a one-dimensional or of a multidimensional control parameter of the wind energy installation arrangement with the aid of an artificial intelligence, in particular by means of this artificial intelligence, on the basis of the eigenvalues and/or eigenvectors which have been determined, in particular using these eigenvalues or eigenvectors as input variables of, or for, the artificial intelligence; and
controlling the wind energy installation arrangement on the basis of the control parameter value which has been determined.

One embodiment of the present invention is based on the surprising realization that such eigenvalues and eigenvectors represent particularly advantageous input variables for an artificial intelligence in order to determine control parameter values for controlling the wind energy installation arrangement, or that, on the basis of such eigenvalues and eigenvectors, the artificial intelligence can improve the operation, in particular the performance, of the single wind energy installation and in particular of a wind energy installation arrangement which comprises a plurality of wind energy installations and/or, in particular at the same time, reduce or limit fatigue loads of individual components of the wind energy installation or wind energy installations.

In accordance with a second aspect of the present invention, a method of controlling a wind energy installation arrangement or the wind energy installation arrangement which comprises one or more wind energy installations, or which, in particular, consists of one or more wind energy installations, comprises the steps of:
determining one or more intensity values, each of which is, or each of which are, respectively, dependent on a standard deviation and a mean value of a rotational speed, in particular a rotational speed of a rotor and / or of a generator, and/or upon a standard deviation and a mean value of a torque, in particular a bending moment of a blade and/or a torque of a rotor and/or of a generator, of the wind energy installation arrangement, in particular of the single wind energy installation of the wind energy installation arrangement or of the individual rotational speeds and/or torques of the plurality of wind energy installations of the wind energy installation arrangement, and/or a standard deviation and a mean value of a wind speed, in particular the absolute value and/or the direction thereof, or which, in accordance with one embodiment, indicates or indicate or describes or describe a ratio of the standard deviation to the mean value;
determining a value or the value of a one-dimensional or multidimensional control parameter or of the one-dimensional or multidimensional control parameter of the wind energy installation arrangement with the aid of an artificial intelligence or with the aid of the artificial intelligence, in particular by means of this artificial intelligence, on the basis of the intensity value which has been determined or, respectively, on the basis of the intensity values which have been determined, in particular using the intensity value which has been determined or, respectively, using the intensity values which have been determined, as input variable or input variables, optionally as a further input variable or as further input variables, of the artificial intelligence or, respectively, for the artificial intelligence; and
controlling the wind energy installation arrangement on the basis of the control parameter value which has been determined.

One embodiment of the present invention is based on the surprising realization that such intensity values (also) represent particularly advantageous input variables for an artificial intelligence in order to determine control parameter values for controlling the wind energy installation arrangement, or that, on the basis of such intensity values, the artificial intelligence can (further) improve the operation, in particular the performance, of the single wind energy installation and in particular of a wind energy installation arrangement which comprises a plurality of wind energy installations and/or, in particular at the same time, (further) reduce or limit fatigue loads of individual components of the wind energy installation or wind energy installations.

As has been indicated above, in accordance with one embodiment, the first and second aspects may be combined with one another, and/or the artificial intelligence may determine the control parameter value on the basis of the eigenvalues or eigenvectors that have been determined, as well as the intensity value or intensity values that has been or have been determined. It has been found that, surprisingly, the operation, in particular the performance, of individual wind energy installations and in particular of a wind energy installation arrangement which comprise a plurality of wind energy installations can be improved to a particularly high degree and/or, in particular at the same time, fatigue loads of individual components of the wind energy installation or of the wind energy installations can be limited or reduced to a particularly high degree by this combination of input variables for an artificial intelligence. Nevertheless, the first or the second aspect can also be implemented on their own, whereby in particular the first aspect can significantly improve the operation, in particular the performance, of a wind energy installation arrangement which comprises a plurality of wind energy installations.

In accordance with one embodiment, the artificial intelligence can comprise, in particular use, a machine-learned relationship between input variables, i. e. in particular the eigenvalues or the eigenvectors and/or the intensity value or intensity values, and the control parameter value, and/or at least one artificial neural network, and/or be trained in advance, or become trained in advance, for this purpose, in particular by means of at least partially supervised and/or reinforced learning. This represents artificial intelligences which are particularly advantageous for the present invention, without these being limited to this.

In accordance with one embodiment, the control parameter value is determined with the aid of the artificial intelligence on the basis of a determined temperature, air humidity and/or air density, wind speed, in particular its absolute value and/or its direction, and/or mode of operation, in particular partial load, full load, start-up or a braking program, active and/or reactive power and/or an active and/or a reactive power requirement, of the wind energy installation arrangement, in particular of the single wind energy installation of the wind energy installation arrangement and in particular of a wind energy installation arrangement with a plurality of wind energy installations, and/or taking into account current requirements of a network operator, in particular of target values for the active and/or reactive power, voltage control or frequency control and/or network characteristics at a transfer point.

It has been found that, surprisingly, the operation, in particular the performance, of individual wind energy installations and in particular of a wind energy installation arrangement which comprise a plurality of wind energy installations, in each case, can be further improved by means of these additional input variables for an artificial intelligence, in particular in combination of two or more of the input variables mentioned above.

In accordance with one embodiment, the values of the first quantity and/or the values of the second quantity are each determined on the basis of values averaged over time, or such an averaging takes place, in a further development on the basis of an averaging over a period of time of at least 10 seconds, in particular at least 30 seconds, and/or at most 10 minutes, in particular at most 2 minutes.

It has been found that, surprisingly, the operation, in particular the performance, of individual wind energy installations and in particular of a wind energy installation arrangement which comprise a plurality of wind energy installations, can be further improved by means of such an averaging over time.

In accordance with one embodiment, the pairs of values are determined over a sliding time window, wherein, in accordance with one embodiment, the sliding time window extends over at least 1 hour, preferably at least 10 hours, in particular at least 2 days, and/or at most 30 days, in particular at most 15 days.

In addition, or as an alternative, in accordance with one embodiment, the pairs of values are determined for one of a plurality of wind direction sectors, in particular for at least four wind direction sectors.

It has been found that, surprisingly, the operation, in particular the performance, of individual wind energy installations and in particular of a wind energy installation arrangement which comprise a plurality of wind energy installations, can be further improved by means of such a sliding time window and such a discretization of the wind direction, in particular in combination. In this context, shorter sliding time windows in the range of 1 to 10 hours can advantageously take into account short-term or more temporary changes in the ambient conditions and/or can improve the sensitivity or the response behavior of the control parameter value optimization. Conversely, longer sliding time windows in the range of 2 or more days can advantageously hide short-term or more temporary changes in the ambient conditions and/or can improve the stability of the control parameter value optimization.

As has already been indicated, the present invention can be used in a particularly advantageous manner for controlling wind energy installation arrangements which comprise at least two wind energy installations, wherein, in accordance with an embodiment of the first aspect, the second quantity is dependent on a power of said at least two wind energy installations, or, respectively, in accordance with an embodiment of the second aspect, an intensity value is dependent on a standard deviation and a mean value of a rotational speed and/or a torque of the one wind energy installation, and at least one further intensity value is dependent on a standard deviation and a mean value of a rotational speed and/or a torque of a further wind energy installation, and the artificial intelligence determines the control parameter value on the basis of these at least two intensity values.

In accordance with one embodiment, permissible ranges for the control parameter values are specified to the artificial intelligence, or such specifying takes place, in particular possible ranges for the control parameter values are restricted to specified permissible ranges, in accordance with one embodiment to plural-dimensional or multidimensional ranges.

By means of this, in accordance with one embodiment, the performance of the artificial intelligence can be improved.

In accordance with one embodiment, an azimuth tracking of the wind energy installation arrangement, in particular of the single wind energy installation of the wind energy installation arrangement or of a plurality of wind energy installations of the wind energy installation arrangement, is changed on the basis of the control parameter value, in particular an offset to an optimal alignment of the azimuth is specified or changed and/or an automatic azimuth tracking is triggered.

In addition, or as an alternative, in accordance with one embodiment, a blade heating and/or de-icing of the wind energy installation arrangement, in particular of the single wind energy installation of the wind energy installation arrangement or of a plurality of wind energy installations of the wind energy installation arrangement, is activated on the basis of the control parameter value.

In addition, or as an alternative, in accordance with one embodiment, a switchover into an energy saving mode of the wind energy installation arrangement, in particular of the single wind energy installation of the wind energy installation arrangement or of a plurality of wind energy installations of the wind energy installation arrangement, is carried out on the basis of the control parameter value, and in accordance with one embodiment, untwisting is carried out, and/or an aligning to a predicted wind direction is carried out.

In addition, or as an alternative, in accordance with one embodiment, the wind energy installation arrangement, in particular the single wind energy installation of the wind energy installation arrangement or a plurality of wind energy installations of the wind energy installation arrangement, is stopped on the basis of the control parameter value, in particular in order to minimize ice accretion during certain meteorological weather conditions.

In addition, or as an alternative, in accordance with one embodiment, a switch is made from one characteristic curve to a different characteristic curve on the basis of the control parameter value, on the basis of which characteristic curve the wind energy installation arrangement, in particular the single wind energy installation of the wind energy installation arrangement or a plurality of wind energy installations of the wind energy installation arrangement, is or are controlled, in particular between pitch characteristic curves, which determine a blade adjustment in the partial load range, generator characteristic curves, which determine a torque, in particular a braking torque or a braking power, or the like.

It has been found that, surprisingly, such control parameter values can, on the one hand, be determined particularly well by an artificial intelligence on the basis of the eigenvalues or the eigenvectors and/or on the basis of the intensity value or intensity values and that, on the other hand, in particular in combination of two or more of these embodiments, the operation, in particular the performance, of individual wind energy installations and in particular of a wind energy installation arrangement which comprise a plurality of wind energy installations can be significantly improved through this.

In accordance with one embodiment of the present invention, a system is set up, in particular in terms of hardware and/or software, in particular in terms of programming, for carrying out a method in accordance with a method described herein, in particular thus in accordance with the first and/or the second aspect, and/or comprises
an artificial intelligence which is set up to determine a value of a control parameter of the wind energy installation arrangement on the basis of determined eigenvalues and/or eigenvectors of a covariance matrix of determined pairs of values and/or on the basis of at least one intensity value, and/or is used for this purpose; and
means for controlling the wind energy installation arrangement on the basis of the control parameter value that has been determined.

In accordance with one embodiment of the present invention, the pairs of values are pairs of values of a first quantity that depends on a wind speed, and a second quantity that depends on a power of the wind energy installation arrangement, and in accordance with one embodiment, the system comprises means for determining the pairs of values of a first quantity that depends on a wind speed, and a second quantity that depends on a power of the wind energy installation arrangement, and/or means for determining the eigenvalues or the eigenvectors of a covariance matrix of the pairs of values that have been determined.

In accordance with one embodiment of the present invention, the at least one intensity value is dependent on a standard deviation and on a mean value of a rotational speed and/or of a torque of the wind energy installation arrangement and/or on a wind speed, and in accordance with one embodiment, the system comprises means for determining the at least one intensity value that is dependent on a standard deviation and on a mean value of a rotational speed and/or of a torque of the wind energy installation arrangement and/or on a wind speed.

In accordance with one embodiment, the artificial intelligence is set up to determine, or is used to determine, the control parameter value on the basis of a determined temperature, an air humidity and/or an air density, a wind speed, and/or a mode of operation, in particular partial load, full load, start-up or a braking program, active and/or reactive power and/or an active and/or a reactive power requirement, of the wind energy installation arrangement, in particular of the single wind energy installation of the wind energy installation arrangement, and in particular of a wind energy installation arrangement with a plurality of wind energy installations, and/or taking into account current requirements of a network operator, in particular of target values for the active and/or reactive power, voltage control or frequency control and/or network characteristics at a transfer point.

In accordance with one embodiment, the system or its means comprises:
means for determining the values of the first and/or the second quantity on the basis of values averaged over time;
means for determining the pairs of values over a sliding time window and/or for one of a plurality of wind direction sectors;
means for specifying permissible ranges for the control parameter values for the artificial intelligence;
means for changing an azimuth tracking of the wind energy installation arrangement on the basis of the control parameter value;
means for activating a blade heating and/or de-icing of the wind energy installation arrangement on the basis of the control parameter value;
means for switching to an energy saving mode of the wind energy installation arrangement on the basis of the control parameter value;
means for stopping the wind energy installation arrangement on the basis of the control parameter value;
means for switching from one characteristic curve to another characteristic curve on the basis of the control parameter value, on the basis of which characteristic curve the wind energy installation arrangement is controlled; and/or
means for ensuring compliance with a specified permissible range of the control parameter value, in accordance with one embodiment a plural-dimensional or multidimensional permissible range of the control parameter value, in particular by means of a wind energy installation control system and/or independently of the determination with the aid of the artificial intelligence. In accordance with this, in one embodiment, the method comprises the step of: ensuring compliance with a specified permissible range of the control parameter value, in accordance with one embodiment a plural-dimensional or multidimensional permissible range of the control parameter value, in particular by means of a wind energy installation control system and/or independently of the determination with the aid of the artificial intelligence.
This is based on the consideration that, with the aid of an artificial intelligence, control parameter values which may potentially be inadmissible could be determined and used as a basis for controlling the wind energy installation arrangement, which could then lead to undesired operation. In accordance with one embodiment, this is countered by specifying permissible ranges for the control parameter values to the artificial intelligence, so that the artificial intelligence cannot, or should not be able to, determine any impermissible control parameter values. In addition, or as an alternative, in accordance with one embodiment, it can also be ensured, in particular by means of a wind energy installation control system and/or independently of the determination with the aid of the artificial intelligence, that a specified permissible range of the control parameter value is complied with, and in accordance with one embodiment, by appropriately limiting and/or checking control parameter values (which have been determined with the aid of the artificial intelligence), in particular by a wind energy installation control system or in a wind energy installation control system, and, if necessary, discarding them and/or replacing them (with permissible control parameter values). Accordingly, if, for example, a control parameter value is determined with the aid of the artificial intelligence that lies outside a specified permissible range, a wind energy installation control system can, in accordance with one embodiment, limit such a control parameter value to a control parameter value within the specified permissible range, in particular to a closest control parameter value within the specified permissible range, or discard the impermissible control parameter value and, in accordance with one embodiment, use a conventional control parameter value or use a control parameter value which has been determined in a conventional manner, or use a standard control parameter value instead.

A means in the sense of the present invention can be constructed in terms of hardware and/or software, and may comprise in particular a processing unit, in particular a microprocessor unit (CPU) or a graphics card (GPU), in particular a digital processing unit, in particular a digital microprocessor unit (CPU), a digital graphics card (GPU) or the like, preferably connected to a memory system and/or a bus system in terms of data or signal communication, and/or may comprise one or more programs or program modules. For this purpose, the processing unit may be constructed so as to process instructions which are implemented as a program stored in a memory system, to acquire input signals from a data bus, and/or to output output signals to a data bus. A memory system may comprise one or more storage media, in particular different storage media, in particular optical media, magnetic media, solid state media and/or other non-volatile media. The program may be of such nature that it embodies the methods described herein, or is capable of executing them, such that the processing unit can execute the steps of such methods and thereby in particular control the wind energy installation arrangement. In accordance with one embodiment, a computer program product may comprise a storage medium, in particular a non-volatile storage medium, for storing a program or having a program stored thereon, and may in particular be such a storage medium, wherein execution of said program causes a system or a control system, in particular a computer, to carry out a method described herein, or one or more of its steps.

In accordance with one embodiment, one or more steps of the method, in particular all steps of the method, are carried out in a fully or partially automated manner, in particular by the system or its means.

In accordance with one embodiment, the system comprises the wind energy installation arrangement.

Controlling in the sense of the present invention may in particular comprise controlling with feedback, and may in particular be controlling with feedback.

In accordance with one embodiment, a method in accordance with the invention is at least partially carried out in a virtualized manner, or is carried out in a virtualized environment. Accordingly, one or more means and/or the artificial intelligence are virtualized, in accordance with one embodiment.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a wind energy installation arrangement comprising a plurality of wind energy installations and a system for controlling said wind energy installation arrangement, in accordance with an embodiment of the present invention;

FIG. 2 shows power curves of one of the wind energy installations for different environmental conditions;

FIG. 3 shows eigenvalues and eigenvectors of a covariance matrix of the pairs of values of the power curves of FIG. 2; and

FIG. 4 shows a method of controlling the wind energy installation arrangement in accordance with an embodiment of the present invention.

### DETAILED DESCRIPTION

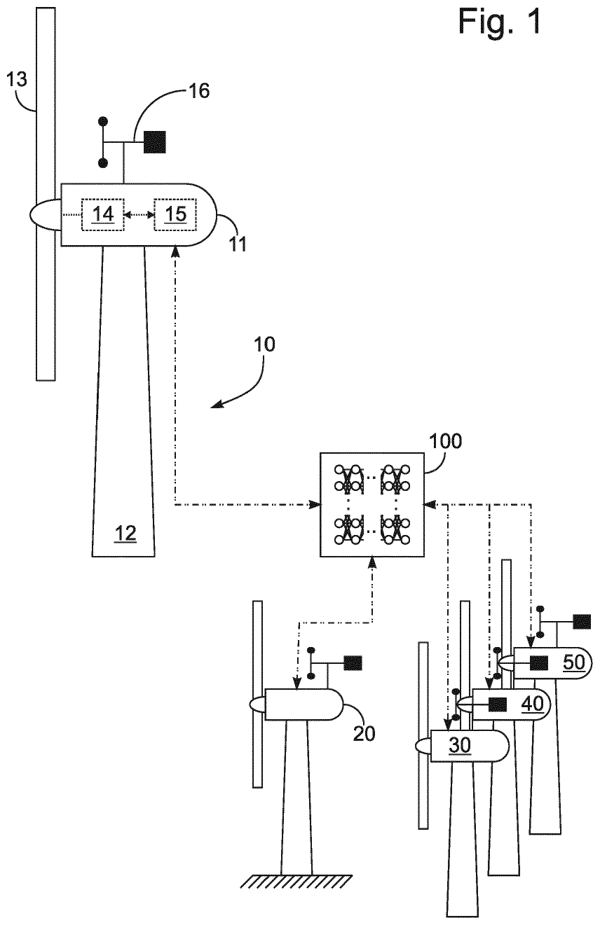

FIG. 1 shows a wind energy installation arrangement or wind farm comprising a plurality of wind energy installations 10, 20, 30, 40, 50 and a system for controlling said wind energy installation arrangement in accordance with an embodiment of the present invention.

As is schematically indicated on the basis of the wind energy installation 10, the wind energy installations each have a rotatable nacelle 11, which is arranged on a tower 12 and which can be tracked, in terms of the azimuth, or which can be rotated about a longitudinal axis of the tower (vertical in FIG. 1) by drives (not shown). A rotor with rotor blades 13 drives a generator 14 which, like a blade angle adjustment system of the rotor blades and the tracking, in terms of the azimuth, is controlled by a control system 15, which receives measurement signals from a wind measuring device 16.

The control systems of the wind energy installations 10, 20, 30, 40, 50 communicate with an artificial intelligence 100, which may comprise one or more neural networks, for example.

In accordance with one embodiment, the artificial intelligence 100 may be installed in a park server of the wind farm. Similarly, data of the control systems may also be exchanged via a Virtual Private Network (VPN) connection with a trusted private network in the cloud, and the artificial intelligence 100 may at least partially be implemented there, in accordance with one embodiment in a virtualized manner.

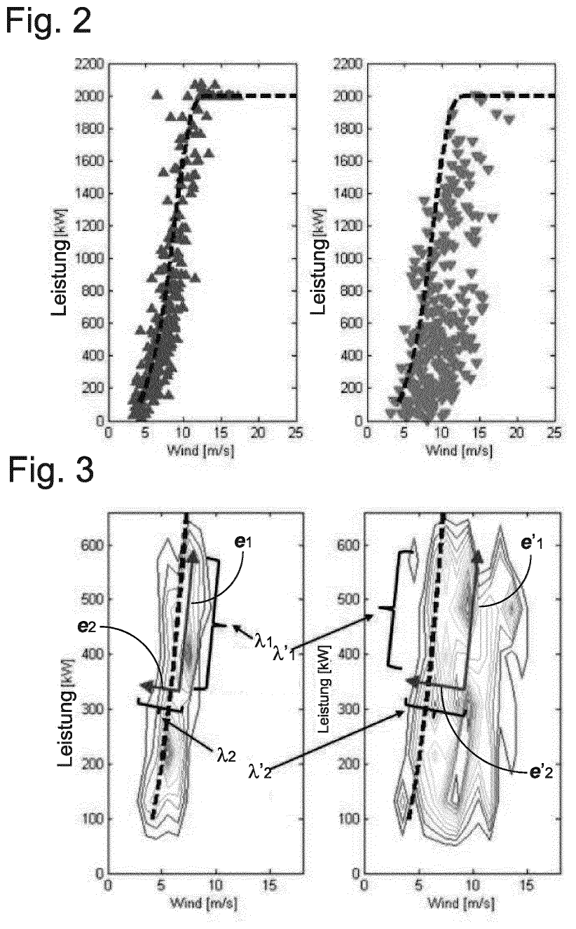

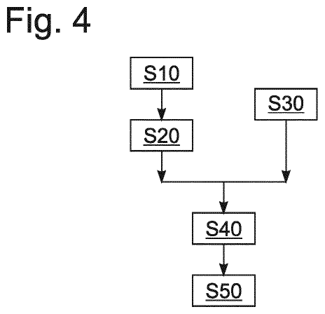

In a first method step S10 (cf. FIG. 2), pairs of values of a first quantity in the form of an absolute value of a wind speed and of a second quantity in the form of a power of the wind energy installations (or wind energy installation arrangement) are determined.

In connection with this, FIG. 2 shows, by way of example, such pairs of values, in the left and right image for different environmental conditions. Here, absolute values of the wind speed are indicated on the abscissa and power values on the ordinate.

In a second method step S20, eigenvalues and eigenvectors of a covariance matrix of these determined pairs of values are determined.

In connection with this, FIG. 3 shows, by way of example, the corresponding eigenvectors e1, . . . e′2 or eigenvalues λ1, . . . λ′2.

In parallel to this, in a step S30, intensity values in the form of ratios of a standard deviation to a mean value of a rotational speed and/or of a torque, in particular a blade bending moment and/or a rotor torque, of the wind energy installations, as well as the wind speed are determined, as it were analogously to the turbulence intensity known per se.

In a method step S40, the—appropriately trained—artificial intelligence 100 determines an optimal value of a control parameter of the wind energy installation arrangement on the basis of these determined eigenvalues and/or eigenvectors and intensity values.

In a step S50, the wind energy installation arrangement is controlled on the basis of this control parameter value that has been determined. For example, corresponding components of the multidimensional control parameter value can be transmitted to the individual control systems, which then control the blade angles, azimuth tracking, generators, de-icing or the like accordingly on the basis of the control parameter value.

Although embodiments have been explained by way of example in the preceding description, it is to be noted that a variety of variations are possible. It is also to be noted that the example embodiments are merely examples which are not intended to limit the scope of protection, the possible applications and the structure in any way. Rather, the preceding description provides the person skilled in the art with a guideline for the implementation of at least one example embodiment, whereby various modifications, in particular with regard to the function and the arrangement of the components described, can be made without departing from the scope of protection as it results from the claims and combinations of features equivalent to these.

### LIST OF REFERENCE SIGNS

10 wind energy installation
11 nacelle
12 tower
13 rotor (blade)
14 generator
15 control system
16 wind measuring device
20-50 wind energy installation
100 artificial intelligence
e₁, . . . e′₂ eigenvector
λ₁, . . . λ′₂ eigenvalue

What is claimed is:

1-9. (canceled)

10. A method of controlling a wind energy installation arrangement which includes at least one wind energy installation, the method comprising:
at least one of:
a) determining with a computer pairs of values of a first quantity which depends on a wind speed, and a second quantity which depends on a power of the wind energy installation arrangement, and
determining eigenvalues and/or eigenvectors of a covariance matrix of the pairs of values of the first and second quantities which have been determined, OR
b) determining at least one intensity value that is dependent on a standard deviation and a mean value of at least one of a rotational speed of the wind energy installation arrangement, a torque of the wind energy installation arrangement, or a wind speed; and
determining a value of a control parameter of the wind energy installation arrangement with the aid of an artificial intelligence based on at least one of:
the determined eigenvalues and/or eigenvectors, or
the at least one determined intensity value; and
controlling the wind energy installation arrangement on the basis of the control parameter value which has been determined.

11. The method of claim 10, wherein the control parameter value is determined with the aid of the artificial intelligence on the basis of at least one of:
a determined temperature, air humidity and/or air density;
a determined wind speed, and/or mode of operation of the wind energy installation arrangement;
an active and/or reactive power of the wind energy installation arrangement;
an active and/or a reactive power requirement of the wind energy installation arrangement; or
taking into account current requirements of a network operator.

12. The method of claim 11, wherein at least one of:
the mode of operation corresponds to a partial load, a full load, a start-up, or a braking program of the wind energy installation arrangement; or
the current requirements of a network operator are at least one of:
target values for the active and/or reactive power,
target values for voltage control or frequency control, or
target values for network characteristics at a transfer point.

13. The method of claim 10, wherein the values of at least one of the first quantity or the second quantity are determined on the basis of values averaged over time.

14. The method of claim 10, wherein the pairs of values are at least one of:
determined over a sliding time window; or
determined for one of a plurality of wind direction sectors.

15. The method of claim 10, wherein:
the wind energy installation arrangement comprises at least two wind energy installations.

16. The method of claim 15, wherein at least one of:
the second quantity is dependent on a power of the at least two wind energy installations, or
the intensity value is dependent on a standard deviation and a mean value of at least one of a rotational speed or a torque of the at least two wind energy installations.

17. The method of claim 10, wherein at least one of:
permissible ranges for the control parameter values are specified to the artificial intelligence; or
compliance with a specified permissible range of the control parameters is enforced.

18. The method of claim 17, wherein at least one:
compliance is enforced by a wind energy installation control system; or
compliance is enforced independently of the artificial intelligence.

19. The method of claim 10, wherein controlling the wind energy installation arrangement on the basis of the control parameter value comprises at least one of:
changing an azimuth tracking of the wind energy installation arrangement;
activating a blade heating and/or de-icing of the wind energy installation arrangement;
switching the wind energy installation over into an energy saving mode of operation;
stopping the wind energy installation arrangement; or
switching the wind energy installation arrangement from control according to a first characteristic curve to control according to a second characteristic curve.

20. A system for controlling a wind energy installation arrangement which includes at least one wind energy installation, the system comprising:
an artificial intelligence for determining a value of a control parameter of the wind energy installation arrangement on the basis of determined eigenvalues and/or eigenvectors of a covariance matrix of determined pairs of values and/or on the basis of at least one intensity value; and
means for controlling the wind energy installation arrangement on the basis of the determined control parameter value;
wherein at least one of:
the pairs of values are pairs of values of a first quantity that depends on a wind speed, and a second quantity that depends on a power of the wind energy installation arrangement, or
the at least one intensity value depends on a standard deviation and a mean value of at least one of a rotational speed of the wind energy installation arrangement, a torque of the wind energy installation arrangement, or a wind speed.

21. A system for controlling a wind energy installation arrangement which includes at least one wind energy installation, wherein the system comprises a controller configured to carry out the method of claim 10.

22. A computer program product for controlling a wind energy installation arrangement which includes at least one wind energy installation, the computer program product comprising program code stored on a non-transitory computer-readable storage medium, the program code, when executed by a computer, causing the computer to:
at least one of:
a) determine pairs of values of a first quantity which depends on a wind speed, and a second quantity which depends on a power of the wind energy installation arrangement, and
determine eigenvalues and/or eigenvectors of a covariance matrix of the pairs of values of the first and second quantities which have been determined, or
b) determine at least one intensity value that is dependent on a standard deviation and a mean value of at least one of a rotational speed of the wind energy installation arrangement, a torque of the wind energy installation arrangement, or a wind speed; and
determine a value of a control parameter of the wind energy installation arrangement with the aid of an artificial intelligence based on at least one of:
the determined eigenvalues and/or eigenvectors, or
the at least one determined intensity value; and
control the wind energy installation arrangement on the basis of the control parameter value which has been determined.
